(19) United States
(12) Patent Application Publication
(10) Pub. No.: US 2008/0243281 A1
(43) Pub. Date: Oct. 2, 2008

(54) Portable device and associated software to enable voice-controlled navigation of a digital audio player

(76) Inventors: Neena Sujata Kadaba, Capistrano Beach, CA (US); Daniel Robert Feldman, Pasadena, CA (US)

Correspondence Address: TOPE-MCKAY & ASSOCIATES, 23852 PACIFIC COAST HIGHWAY #311, MALIBU, CA, 90265, US

(21) Appl. No.: 12/074,375

(22) Filed: Mar. 3, 2008

Related U.S. Application Data
(60) Provisional application No. 60/904,713, filed on Mar. 2, 2007.

(51) Int. Cl. G06F 17/00

(52) U.S. Cl. 700/94

(57) ABSTRACT

Methods are disclosed to describe a portable device that enables the user to navigate the menus of a digital audio player using a set of simple voice commands. The system is comprised of a microcontroller, serial flash memory device, on-board microphone, volume controller, a connector for headphones or external audio amplifier and a connector for an external microphone. Power is supplied by the digital audio device via a connector. The device is loaded with necessary software to interface with the digital audio player using Transistor-Transistor-Logic-level serial commands. The loaded software allows for a search for playlists, artists, albums, genres, or songs, which is accomplished via an extremely low memory ASCII character comparison with sublinear performance functionality.

### PRIORITY CLAIM

The present application is a non-provisional patent application, claiming the benefit of priority of U.S. Provisional Application No. 60/904,713, filed on Mar. 2, 2007, entitled, “A PORTABLE DEVICE AND ASSOCIATED SOFTWARE TO ENABLE VOICE-CONTROLLED NAVIGATION OF A DIGITAL AUDIO PLAYER.”

### BACKGROUND OF THE INVENTION

(1) Field of Invention

The invention relates to the navigation of digital audio players, specifically to the development of a voice-controlled external portable device for navigation of a digital audio player.

(2) Description of Related Art

In recent years digital audio players have become ubiquitous devices. Unfortunately, navigating these devices requires both visual contact with the screen and hand control of the device. There is currently no system for navigating these devices in all settings using voice commands.

A digital audio player is a device that allows the user to listen to music or sound in a digital format. Users rely upon these devices for listening to music in a variety of settings, including at the gym, while outdoors or in the car, while at work or in the home. The navigation of menus and the selection of the desired songs, however, relies upon reading the menus and manually pushing buttons. These behaviors, while appropriate in some circumstances, can pose serious safety problems while driving, or become an inconvenience in other situations. While using gym equipment, running, or otherwise using both hands, users may hope to avoid reading and scrolling through menus despite wanting to listen to music.

Therefore, there is a need for an affordable, portable device which allows for hands-free, voice-activated control of a digital audio player. Such a device would provide the option to navigate the menus of the digital audio player quickly without devoting full visual attention and hand control to song selection. This navigation would be accomplished with a small set of speaker-independent voice commands that enables recognition with high accuracy and minimum delay.

### SUMMARY OF INVENTION

The present invention is a fully functional, voice-controlled, hands-free device for navigating and controlling a digital audio player.

The device comprises an input for receiving an audio segment/command of information from a user. A microcontroller is communicatively connected with the input for receiving the segment and recognizing and mapping the segment to an electronic segment representative of the audio information.

When the audio segment received by the microcontroller is a command, the microcontroller executes the command. When the audio segment received by the microcontroller represents an alpha-numeric symbol, the microcontroller collects a set of alpha-numeric symbols and searches a database of computer files based on the set of alpha-numeric symbols to find a closest match.

An output is connected with the microcontroller for transmitting the results of the microcontroller database search to the user, whereby a user can input a command or alpha-numeric symbol into the device, and the device will execute the command or perform a search on the alpha-numeric symbol, and produce an appropriate output to the user.

In another aspect of the present invention, the computer files accessed by the microcontroller are audio files stored on a digital audio player, the microcontroller is connected with the digital audio player to provide Transistor-Transistor Logic voltage level commands thereto.

In yet another aspect, the search performed by the microcontroller is an extremely low memory string comparison search.

In a further aspect, the search performed by the microcontroller is selected from a group consisting of a linear search and a hash-table based search.

In another aspect of the present invention, the device has a size not to exceed 4.5 inches by 2.5 inches by 1 inch, thereby making the device easily portable by hand or in a standard pant pocket.

As can be appreciated by one skilled in the art, the present invention also comprises a method for controlling the voice controlled navigation device described herein.

Finally, as can be appreciated by one skilled in the art, the present invention also comprises a computer program product comprising computer-readable instructions for causing a microcontroller to perform the operations described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a top view illustration of the device;

FIG. 2 is a left profile view of the device;

FIG. 3 is a right profile view of the device;

FIG. 4 is a front perspective view of the device;

FIG. 5 is a schematic diagram of the hardware contained in the device;

FIG. 6 is a flow chart detailing the functions utilized by the microcontroller;

FIG. 7 is a schematic diagram describing the extremely low memory string comparison method that is exercised both in the linear and hash table search modes for determining the existence of the selection string on the page being searched;

FIG. 8 is an diagram depicting creation of a hash table;

FIG. 9 is a schematic diagram of the hash table searching functionality;

FIG. 10 is a schematic diagram of the interruptive selection playback loop function of the device; and

FIG. 11 is a schematic diagram of the user interface with the device showing a menu timeout function.

### DETAILED DESCRIPTION

The invention relates to the navigation of digital audio players, specifically to the development of a voice-controlled external portable device for navigation of a digital audio player. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Further, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. As such, as the device is turned around and/or over, the above labels may change their relative configurations.

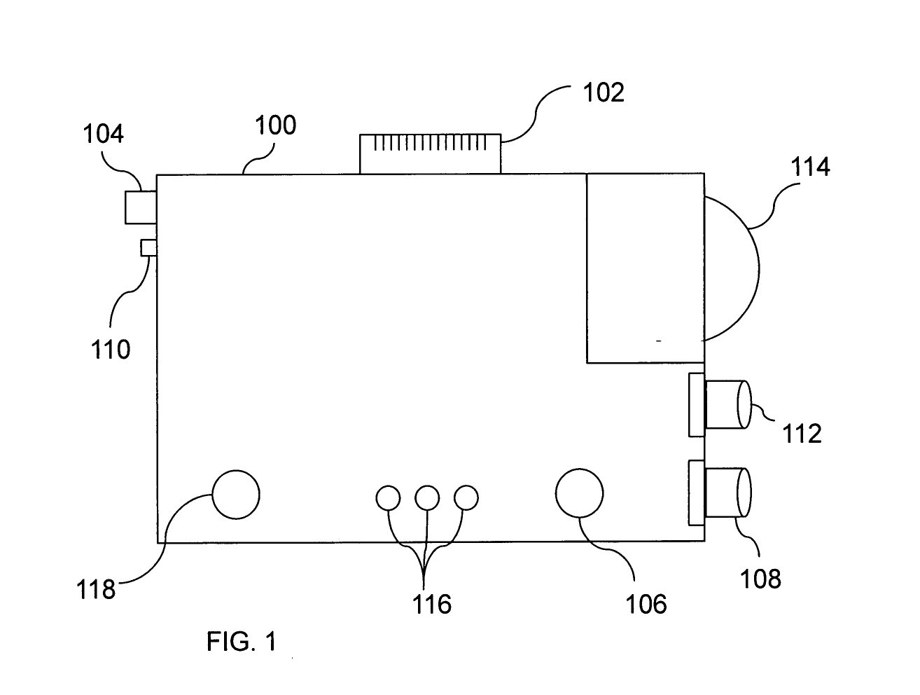

The present invention relates to a portable, hand-held, voice controlled navigation device for navigation of a digital audio player. FIG. 1 illustrates a front view of the device 100 according to the present invention. The device 100 includes a dock connector 102 for connecting with a digital audio player. The dock connector 102 functions to transfer information between the device 100 and an attached digital audio player, as well to route power from the digital audio player to power the device 100. The device 100 has a reset button 104 for resetting the device 100. The device 100 also has inputs 106 and 108 for receiving audio segments/commands from a user. In the embodiment shown in FIG. 1, the inputs comprise an internal microphone 106 and a microphone jack 108 for connection with an external microphone. The device also has a microphone switch 110 for allowing a user to switch between the internal microphone 106 and an external microphone connected through the microphone jack 108. The device also has an output 100. The output 100 comprises an audio jack for connection with external speakers. The device 100 also has a volume dial 114 for adjusting volume, LED indicators 116 for indicating the status of the device 100, and an optimization button 118 for optionally optimizing the search functions of the device 100.

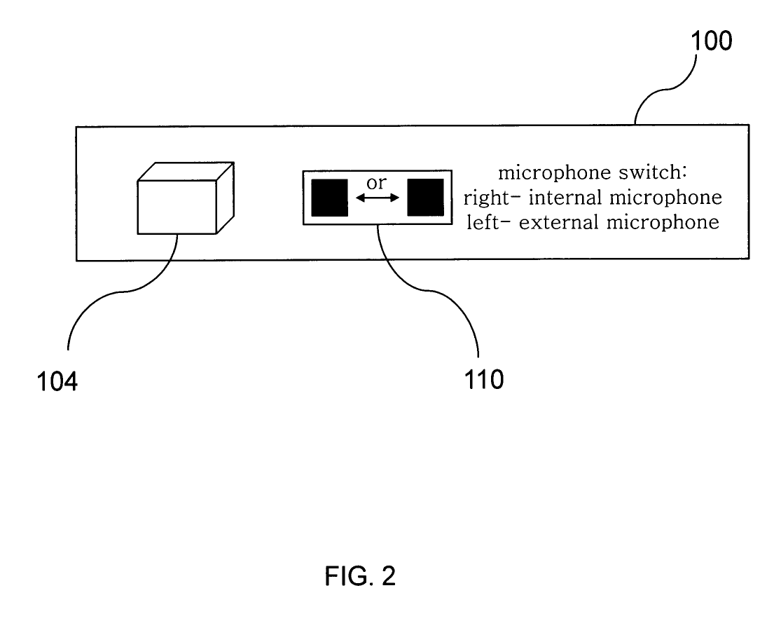

FIG. 2 is a left profile view illustration of the device 100 showing the reset button 104 and microphone switch 110. In the embodiment shown in FIG. 2, the microphone switch comprises a slide switch. Other non-limiting examples of a microphone switch 110 include a button and a lever-switch.

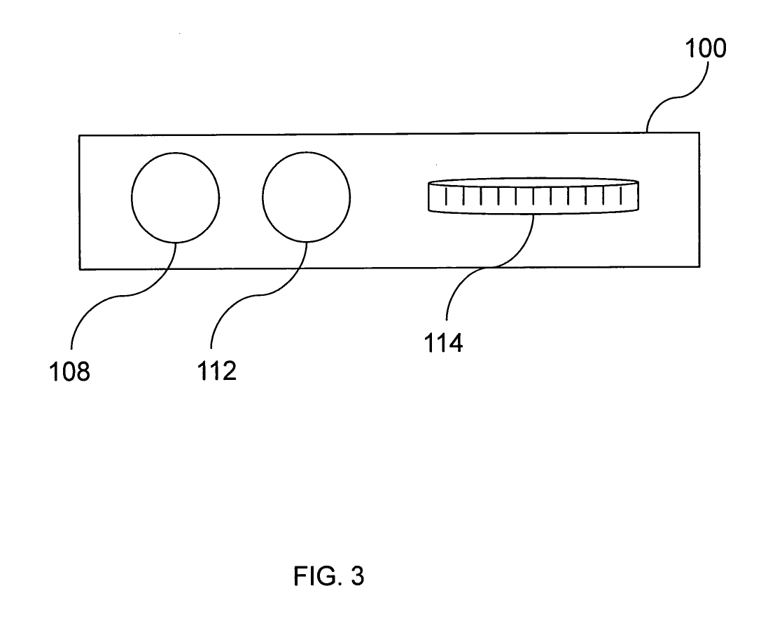

FIG. 3 is a right profile view of the device 100 showing the volume dial 114, the microphone jack 108, and the audio jack 112.

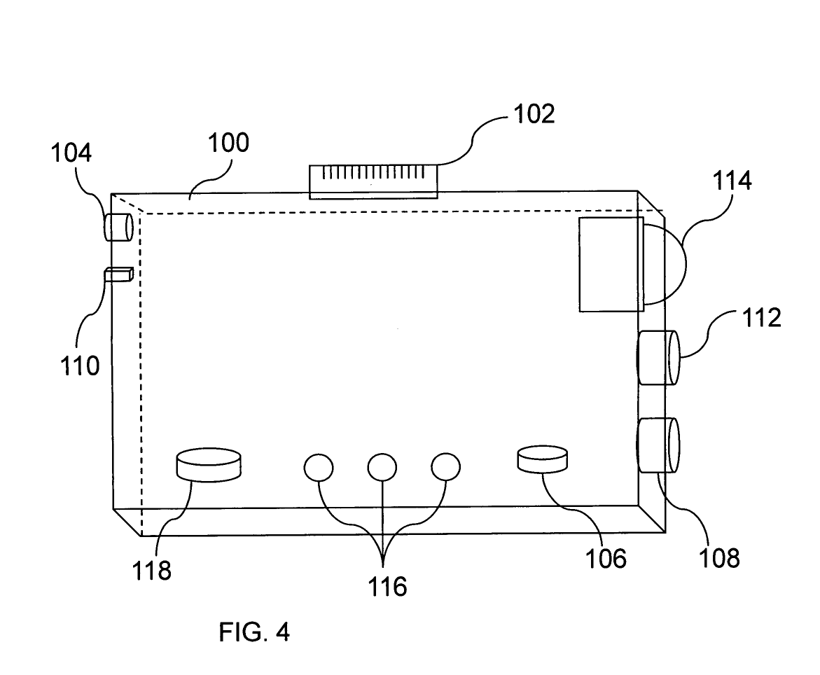

FIG. 4 is a front perspective view of the device 100 in accordance with the present invention.

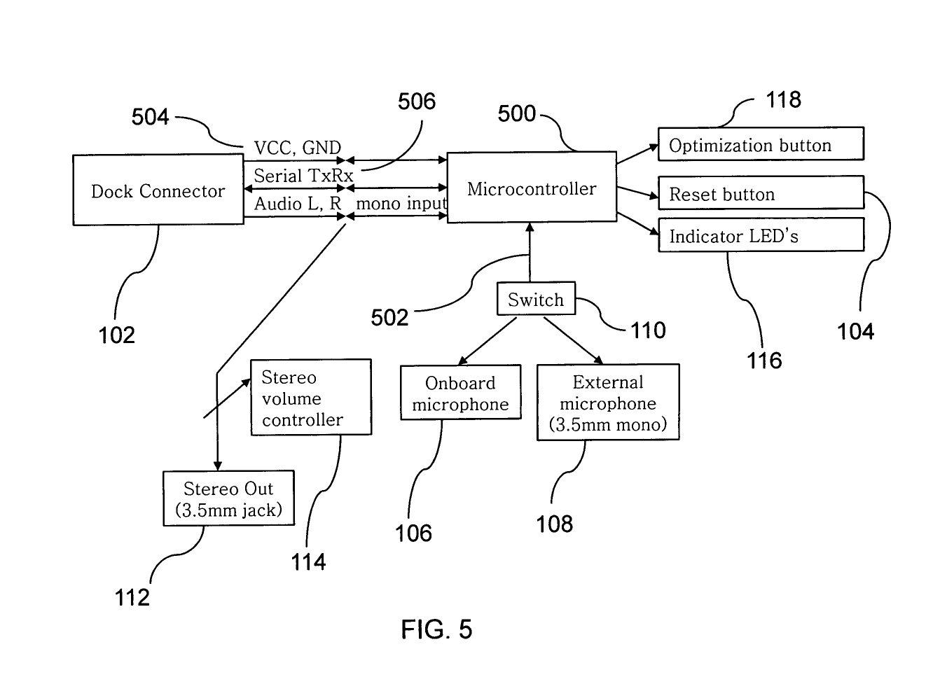

FIG. 5 is a schematic diagram of the hardware contained in the device 100. The device contains a microcontroller 500 for receiving an audio segment of information through an input 502, the input being selected from an internal microphone 106 and an external microphone 108 using a microphone switch 110. As can be appreciated by one skilled in the art, a microcontroller capable of performing the functions in the present invention can be made by mounting standard electronic components on a printed circuit board. A non-limiting example of a combination of components suitable for creating a microcontroller as in the present invention are, an 8-bit processor with onboard flash for code storage, RAM, oscillator, microphone input pins, audio-out pins, and serial byte transmit and receive pins, and a 32-megabit serial flash memory chip.

The microcontroller 500 is communicatively connected with a dock connector 102 though which the microcontroller 500 receives power 504 (VCC high voltage and GND low voltage), transmits and receives serial protocol 506, as well as audio L, R, and mono input 507. The microcontroller 500 can receive signals from the user through the optimization button 118 and the reset button 104, and will indicate the status of the device 100 through transmission of signals to indicator LED's 116. External speakers or headphones connected to the device 100 through an audio jack 112 can receive output from the microcontroller 500 or from the digital audio device through connection with the dock connector 102.

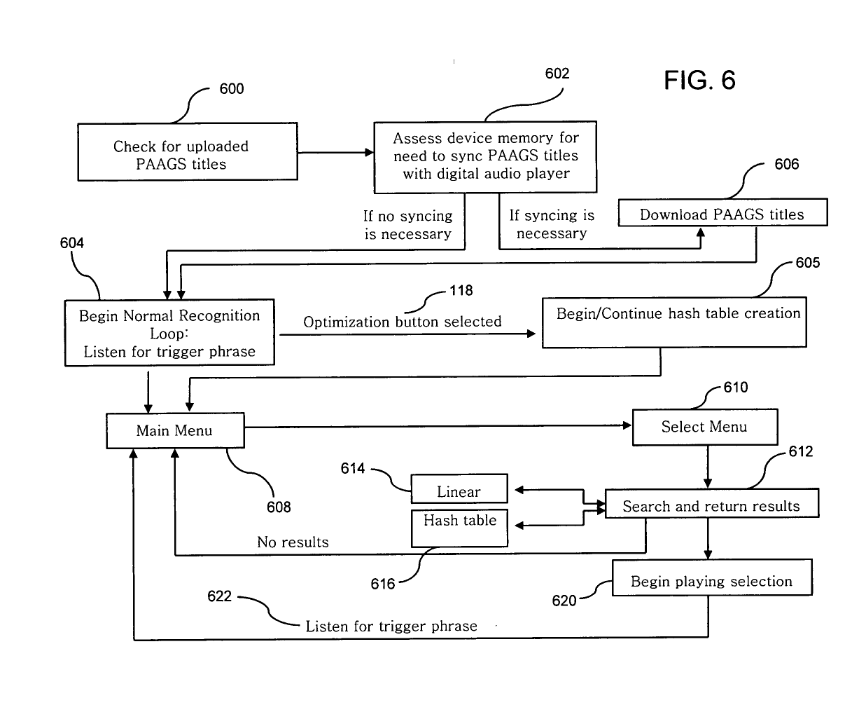

FIG. 6 is a flow chart describing the functions utilized by the microcontroller. When the device 100 is initially powered up, a check of its serial-flash memory for the existence of playlists, artists, albums, genres, or songs (hereafter referred to as PAAGS) titles is performed 600. Then microcontroller assesses the device memory 602 to determine if there is a need to sync PAAGS titles with the digital audio player. If the PAAGS numbers listed on the first pages of the serial-flash memory of the device match the PAAGS numbers on the digital audio player, then the microcontroller 500 begins a normal recognition loop 604 where the microcontroller listens for a trigger phrase inputted by the user. If the PAAGS numbers listed on the first pages of the serial-flash memory do not equal the PAAGS numbers on the digital audio player, the external device begins the syncing procedure 606.

The syncing procedure consists of issuing Transistor-Transistor-Logic (TTL) level serial commands to the digital audio player to transfer PAAGS titles from the digital audio player to the device 100; during a transfer, the digital audio player PAAGS titles are stored on the serial flash memory of the device 100 along with a 3-byte header which includes the 2-byte PAAGS index number and a 1-byte description of the length of the PAAGS title. The PAAGS titles and headers are stored sequentially on the of 512-byte serial flash memory pages with no titles bridging pages. After the syncing is completed, the new number of PAAGS is recorded on the first page and the device 100 begins the normal recognition loop 604.

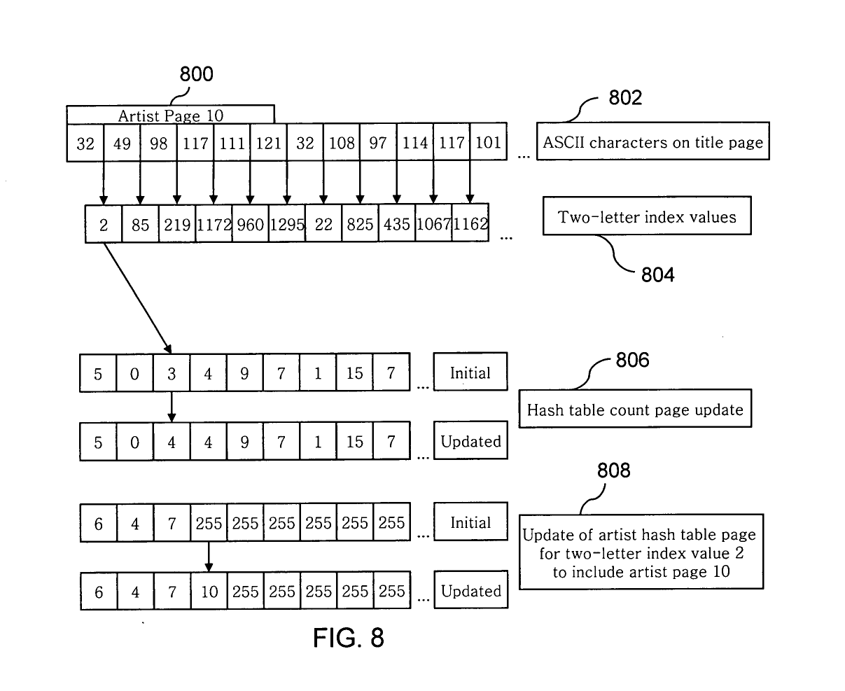

While the device is in the normal recognition loop 604, if the user has activated the optimization button 118, the normal recognition functions are suspended for creation of a hash table 605 enabling the device to perform a faster PAAGS search. In the present invention, hash table creation is accomplished through activation of a pushbutton switch 118. Other non-limiting examples of an acceptable activation mechanism would be a slide switch, a lever switch, or a delay mechanism where the device would automatically create a hash table when the device is not being actively used for voice navigation. The workings of the hash table are described in greater detail in the description of FIG. 8 below.

In the normal recognition loop, the device 100 listens for a designated trigger phrase 604 in the form of a verbal audio segment from a user; after successful recognition of the trigger phrase, the external device algorithm enters the main menu 608 for navigation. The selection of PAAGS is accomplished through listening for audio segments from the user and sending appropriate TTL level serial commands to the digital audio player. Non-limiting examples of audio segment designates provided by a user in the main menu 608 are “playlists,” “artists,” “albums,” “genres,” or “songs.” Upon successful recognition of the search designate, the external device algorithm enters the selection menu 610.

In the selection menu 610, the device 100 listens for a string of selection characters (0-9, A-Z, space) that are sequentially spoken by the user and records these results in external serial flash memory. The device will be able to designate a spoken word such as “Sinatra,” or through a series of spoken letters, such as “S, I, N, A, T, R, A.” When the user is finished designating selection characters, the user may give a “stop” command. After designation of the “stop” command in the selection menu 610, the device 100 begins the searching process 612.

The device 100 may perform either a linear search 614 or a hash table search 616. The device 100 will perform a linear search by default, and will provide a hash table search if the user has selected the optimization button 118. If the search produces no results 618, then the device enters the main menu 608 and awaits another search designate command from the user. If the search results in a match, then the device will begin playing the selection. If the search results in multiple matches, then the device will begin playing the selections in alphabetical order. While the selection is playing, user may prompt the device 100 to return to the main menu at any time by inputting a trigger phrase into the device 100.

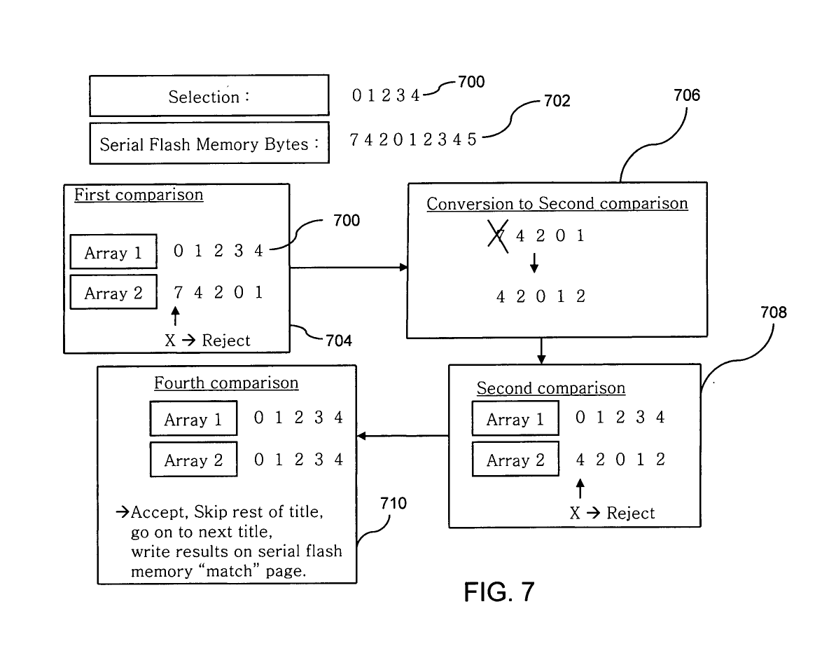

FIG. 7 is a schematic diagram describing the extremely low memory string comparison method that is exercised both in the linear and hash table search modes for determining the existence of the selection string on the memory page being searched. The searching process is an extremely low-memory algorithm that sequentially compares the array of ASCII numbers selected by the user 700 with the array of ASCII numbers stored in the serial flash memory 702. Unlike normal string-string comparison algorithms, the sequential comparison execution is streamlined so that matches and discrepancies between the selection and the PAAGS title data on flash memory short-cut the string-string comparison. This comparison algorithm only compares strings of equal length rather than loading the full length of both strings into memory, thereby saving several bytes of memory. The search begins with a first comparison 704 of the selection string 700. In this step, the selection string 700, in this case a 5-byte string “01234,” is compared against the first five bytes of a serial flash memory string “74201.” If the selection string does not match the serial flash memory string, the comparison is rejected and the search proceeds to convert the serial flash memory string for a second comparison. In the conversion to second comparison 706, the serial flash memory string is shifted one to the right, so that “74201” is now “42012.” In a second comparison 708, the selection string is compared against the new serial flash memory string. In this example the strings do not match and the comparison is rejected. The search will repeat the conversion/comparison process until the selection string matches the serial flash memory string or until the entire memory page has been searched. In this example, the search will find a match on the fourth comparison 710. At this point the search on that particular title ends and the results are written on a serial flash memory “match” page 712.

The search process also has the capability of performing a faster search by means of a hash table which limits the number of serial flash memory pages searched. The time required to open a serial flash memory page is many times longer than the time required to perform a serial search on the page, therefore opening the serial flash memory page is the rate-limiting step in the search process. The creation of a hash table at the beginning of the search process will greatly reduce search time by limiting the number of serial flash pages that must be opened during the search.

FIG. 8 is a depiction of the creation of a hash table. In particular, the creation of a hash table for a hypothetical “Artist Page 10” 800 in the serial flash memory. In the first step of hash table creation, each pair of adjacent ASCII characters on the title page 802 are mapped into two-letter index values 804. In this case, the adjacent ASCII values “32” and “49” map to the two-letter index value “2.” A hash table count page 806 keeps a running total of the number of occurrences of each two-letter index value 804. In this case, the two letter index value “2” has “3” previous occurrences in the hash table count page 806. The hash table count page is then updated to add another occurrence, changing the number “3” to a “4” on the hash table count page 806. Lastly, the artist hash table page is updated to show on which pages the two-letter index values are located. The initial artist hash table page 808 indicates matches on pages “6,” “4,” and “7.” The page is updated to add the next occurrence, which occurs on artist page “10.” Note that the number “255” denotes a blank spot in serial protocol. In the present artist hash table page update, a blank spot “255” is being replaced by a “10” to denote that the selected two-letter index value 804 is found on “Artist Page 10” 800.

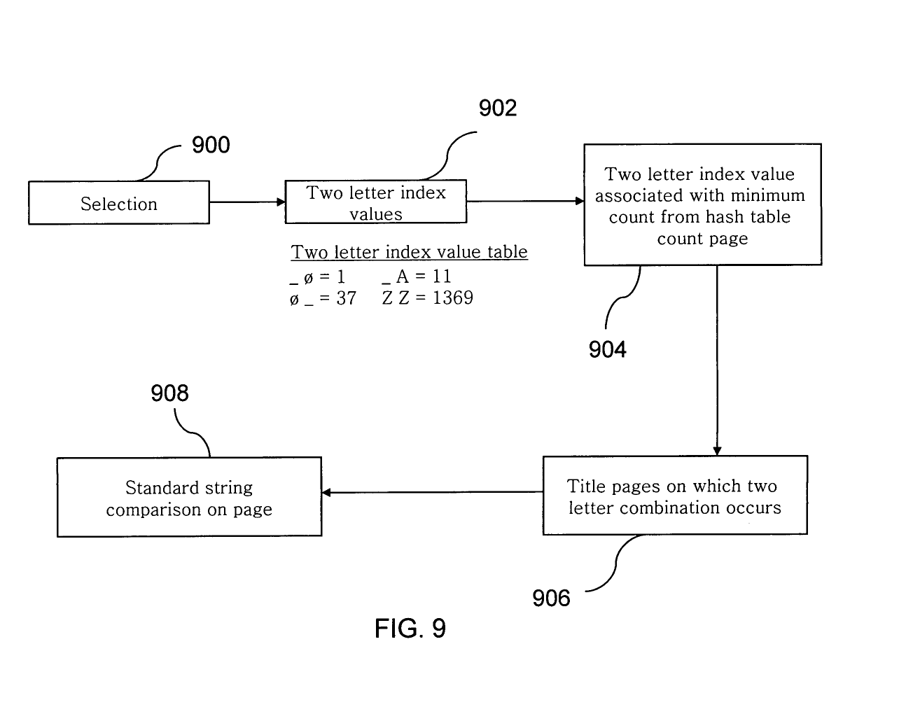

FIG. 9 is a schematic diagram of the hash table searching functionality. After the input of a selection 900 from the user, all two-letter combinations in the selection 900 are mapped onto a hash table count page 806 as previously described in FIG. 8. The hash table count page 806 can be represented as a two letter index value table 902, showing the number of occurrences of each two letter index value on that page. The two letter index value 902 with the fewest occurrences is selected. As shown in the example in FIG. 9, the two letter index value “_{—}0” will be selected because it only has 1 occurrence on the hash table count page. Next, the search will identify the title page on which the selected two-letter combination occurs and opens that page 906. A standard string comparison 908 of the selected page is then performed, as previously illustrated in FIG. 7.

Each result possessing the search criteria is tabulated according to its PAAGS index number. Next, the external device sends TTL-level serial commands to the digital audio player to begin playing the PAAGS titles selected by going in sequential order through the PAAGS index numbers that correspond to successful search matches. The external device also sends TTL-level serial commands to ascertain the length of each song and the amount of time remaining in each song.

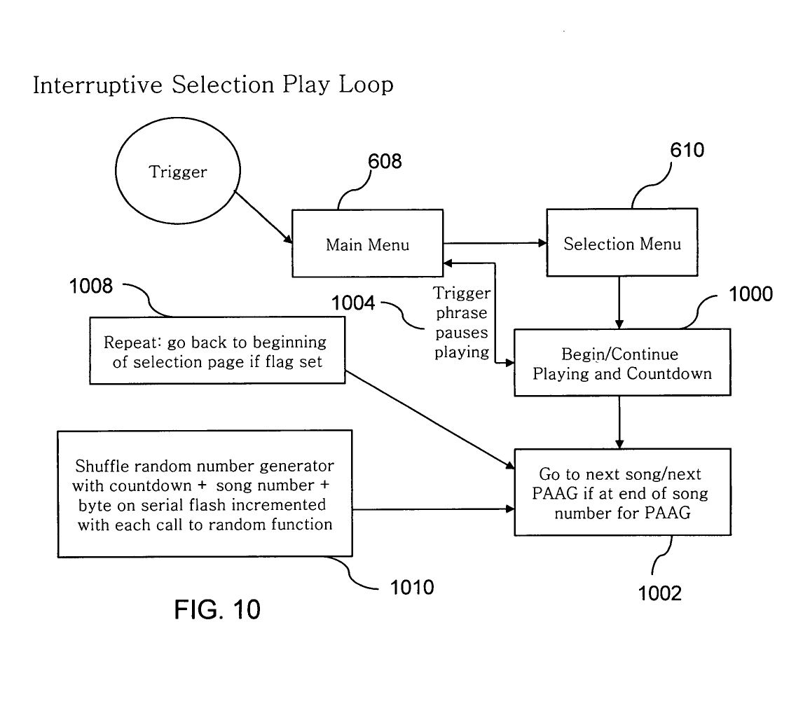

Accordingly, and as shown in FIG. 10, the device uses a countdown timer 1000, facilitated through an interrupt handler, which allows the device to change to the next PAAGS selection once the digital audio player has finished with the song in question 1002. The external device also supports interruption of music play 1004 through input of a verbal trigger phrase so that the user can halt the current selection and return to the main menu 608 to make a new selection at any point during the playing of the set of song selections. The user also can navigate his/her selection of PAAGS through simple, recognition-error resistant voice commands. This navigation includes: pausing the selection indefinitely, resumption of playing of the selection, and stepping back and forth between different songs. Also included for playlist, artist, album, and genre searches is the ability to skip the songs of the current playlist, artist, album, or genre and move on to the next or previous one.

The device also supports options to repeat 1008 and shuffle 1010 selections according to user preferences. If the repeat flag is set 1008, the option is invoked once the entire selection has been played, whereupon the selection count is reset to zero and the play loop begins again. If the shuffle flag is set, a pseudo-random number is generated to determine which PAAGS to select. The creation of the pseudo-random number is seeded with the countdown timer setting, the current PAAGS number, and designated random number byte from the serial flash memory that is incremented with each call to a random number generator. The seed is then multiplied by a large prime number after which the modulus operator is applied per the selection size.

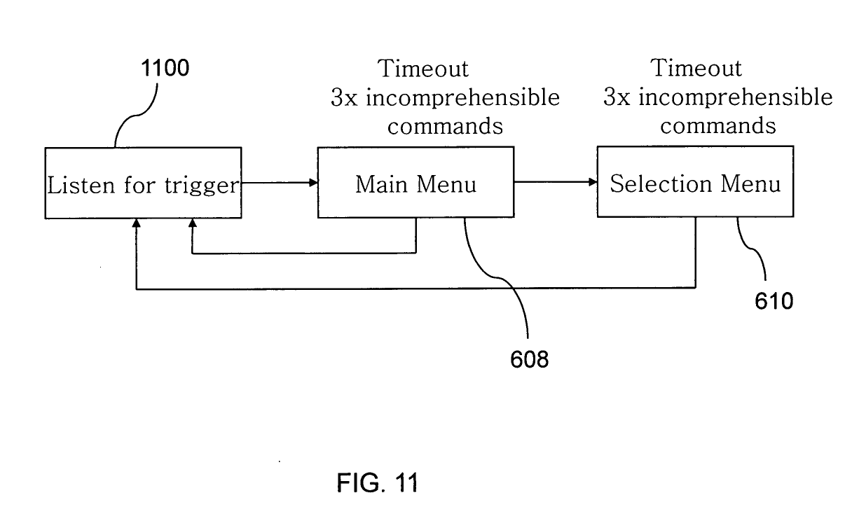

FIG. 11 is a schematic diagram of the user interface with the device showing a menu timeout function, whereby when the device is in the main menu 608 or the selection menu 610, the device will timeout after a pre-determined time period, or after receiving a pre-determined number of consecutive incomprehensible commands and return to listening for triggers 1100. In the embodiment shown in FIG. 11, the device will timeout after receiving three incomprehensible commands.

What is claimed is:

1. A portable, hand-held voice-controlled computer file navigator comprising:
an input for receiving an audio segment of information from a user;
a microcontroller communicatively connected with the input for:
receiving the segment and recognizing and mapping the segment to an electronic segment representative of the audio information such that:
when the audio segment represents a command, executing the command; and
when the audio segment represents an alpha-numerical symbol, collecting a set of alpha-numerical symbols and searching a database of computer files based on the set of alpha-numerical symbols to find a closest match; and
an output connected with the microcontroller for transmitting the results of the microcontroller database search to the user.

2. A voice-controlled computer file navigator as set forth in claim 1, wherein the computer files accessed are audio files stored on a digital audio player, and where the microcontroller is connected with the digital audio player to provide Transistor-Transistor Logic (TTL) voltage level commands thereto.

3. A voice-controlled computer file navigator as set forth in claim 2, wherein the search performed by the microcontroller is an extremely low memory string comparison search.

4. A voice-controlled computer file navigator as set forth in claim 3, wherein the extremely low memory string comparison search performed by the microcontroller is selected from a group consisting of a linear search and a hash-table based search.

5. A portable handheld device as set forth in claim 4, wherein the device has a size not to exceed 4.5 inches by 2.5 inches by 1 inch.

6. A voice-controlled computer file navigator as set forth in claim 1, wherein the computer files accessed are audio files stored on a digital audio player, and where the microcontroller is connected with the digital audio player to provide Transistor-Transistor Logic voltage level commands thereto.

7. A voice-controlled computer file navigator as set forth in claim 1, wherein the search performed by the microcontroller is an extremely low memory string comparison search.

8. A voice-controlled computer file navigator as set forth in claim 1, wherein the search performed by the microcontroller is selected from a group consisting of a linear search and a hash-table based search.

9. A portable handheld device as set forth in claim 1, wherein the device has a size not to exceed 4.5 inches by 2.5 inches by 1 inch.

10. A method for controlling navigation of a computer file system comprising acts of:
receiving an audio segment of information from a user;
recognizing and mapping the segment to an electronic segment representative of the audio information such that:
when the audio segment represents a command, executing the command; and
when the audio segment represents an alpha-numerical symbol, collecting a set of alpha-numerical symbols and searching a database of computer files based on the set of alpha-numerical symbols to find all matches possessing the desired set of alpha-numerical symbols; and
signaling the digital audio player to transmit the selection to the user.

11. A computer program product comprising computer-readable instructions for causing a microcontroller to perform operations of:
receiving an audio segment of information from a user;
recognizing and mapping the segment to an electronic segment representative of the audio information such that:
when the audio segment represents a command, executing the command; and
when the audio segment represents an alpha-numerical symbol, collecting a set of alpha-numerical symbols and searching a database of computer files based on the set of alpha-numerical symbols to find all matches possessing the desired set of alpha-numerical symbols; and
signaling the digital audio player to transmit the selection to the user.
